(19) United States
(12) Patent Application Publication
(10) Pub. No.: US 2003/0115312 A1
(43) Pub. Date: Jun. 19, 2003

(54) Identifying network servers capable of hosting a database

(75) Inventors: Dennis Russell Beilhartz, Newmarket (CA); Baldev S. Soor, Markham (CA)

Correspondence Address: John L. Rogitz, Rogitz & Associates, Suite 3120, 750 B Street, San Diego, CA, 92101, US

(73) Assignee: International Business Machines Corporation, Armonk, NY (US)

(21) Appl. No.: 10/306,755

(22) Filed: Nov. 26, 2002

(30) Foreign Application Priority Data
Dec. 19, 2001 (CA) 2,365,691

(51) Int. Cl. G06F 15/173

(52) U.S. Cl. 709/223

(57) ABSTRACT

An identification mechanism for identifying network servers capable of database hosting. The network servers are also capable of transmitting identification indicating their capability to host a database. The identification mechanism requests an allocation of memory to receive transmitted identification of network servers capable of database hosting. Then the mechanism transmits a broadcast message, to the collection of network servers via the network, requesting transmission of identification of the network servers capable of database hosting. The mechanism waits for the allocated memory to receive transmissions of identification of network servers capable of database hosting. Subsequently, the mechanism provides the received transmitted identification from the allocation of memory.

### I. FIELD OF THE INVENTION

This invention relates to ascertaining server resources, and more specifically to identifying network servers capable of hosting a database.

### II. BACKGROUND OF THE INVENTION

Identification of network servers that host databases has been performed by a computer connected over a network executing a program that initiates a generic, connectionless request to network servers via the network, and subsequently attempting to receive and process each response as it arrives from the interrogated network servers. Responses can be lost when a computer system processes received transmitted responses. Accordingly, a mechanism that addresses, at least in part, this and other shortcomings is desired.

### SUMMARY OF THE INVENTION

The present invention seeks to provide a mechanism for preparing a computer system to substantially receive responses having identification of network servers capable of hosting a database.

The present invention provides an identification mechanism for identifying network servers capable of database hosting. The network servers are also capable of transmitting identification indicating their capability to host a database. The identification mechanism operates over a network for networking a collection of network servers in which some are network servers capable of hosting a database. The identification mechanism begins by requesting an allocation of memory to receive transmitted identification of network servers capable of database hosting. Then the mechanism transmits a broadcast message, to the collection of network servers via the network, requesting transmission of identification of the network servers capable of database hosting. The mechanism waits for the allocated memory to substantially receive transmissions of identification of network servers capable of database hosting. Subsequently, the mechanism provides the received transmitted identification from the allocation of memory.

The present invention also provides a response mechanism for transmitting identification indicating capability of database hosting in response to receiving a transmitted broadcast message for requesting transmission of identification network servers capable of database hosting. The response mechanism operates over a network. The response mechanism determines whether a network server has received the transmitted broadcast message via the network, and if it did receive the transmitted broadcast message, the response mechanism requests transmission, via the network, of identification of network server capable of database hosting.

In one aspect of the present invention, there is provided an identification mechanism for use by a data processing system having associated memory for identifying database servers on a network capable of hosting databases, including a transmitter for transmitting a broadcast message requesting identification responses from database compatible servers connected to a network to determine whether they are capable of hosting a database, a receiver for receiving the responses and passing them to the memory, and a controller for storing the received responses in the memory and for reading the stored responses from the memory after a predetermined period of time sufficient to enable storing of expected responses.

In another aspect of the present invention, there is provided a computer program product for use in a computer system operatively coupled to a computer readable memory, the computer program product including a computer-readable data storage medium tangibly embodying computer readable program instructions for implementing the identification mechanism described above.

In yet another aspect of the present invention, there is provided a data processing system having an identification mechanism with associated memory for identifying database servers on a network capable of hosting databases, including a transmitter for transmitting a broadcast message requesting identification responses from database compatible servers connected to a network to determine whether they are capable of hosting a database, a receiver for receiving the responses and passing them to the memory, and a controller for storing the received responses in the memory and for reading the stored responses from the memory after a predetermined period of time sufficient to enable storing of expected responses.

In yet another aspect of the present invention, there is provided a computer program product for use in a computer system operatively coupled to a computer readable memory, the computer program product including a computer-readable data storage medium tangibly embodying computer readable program instructions for implementing the data processing system described above.

In yet another aspect of the present invention, there is provided an identification mechanism for a database compatible server connectable to a network for sending and receiving messages for identifying database servers on a network capable of hosting databases, including a receiver for receiving a message requesting identification of the database compatible server from a data processing system, a responder for responding to the message requesting identification to generate a response thereto identifying that the database compatible server is capable of hosting a database, and a transmitter for transmitting the response to the data processing system.

In yet another aspect of the present invention, there is provided a method for use by a data processing system having memory for identifying database compatible servers connected to a network, including transmitting a broadcast message requesting responses from the database compatible servers to determine whether they are capable of hosting a database, receiving the responses in the memory, storing the responses in memory, waiting for a preselected time sufficient to receive expected responses, and reading the responses from the memory.

In yet another aspect of the present invention, there is provided a method for allowing a database compatible server connected to a network to identify itself, including receiving a message requesting identification the database compatible server from a data processing system, and preparing a response to the message requesting identification of the database compatible servers capable of hosting a database. In yet another aspect of the present invention, there is provided a computer program product for use in a computer system operatively coupled to a computer readable memory, the computer program product including a computer-readable data storage medium tangibly embodying computer readable program instructions for implementing any of the methods described above.

These and other embodiments of the present invention are shown in the following drawings and description of the preferred embodiments.

### BRIEF DESCRIPTION OF THE DRAWINGS

The embodiments of the present invention will be explained by way of the following drawings:

FIG. 1 depicts a network environment including a networked computer embodying aspects of the present invention, and a network server capable of hosting a database;

FIG. 2 depicts operations of the computer system of FIG. 1; and

FIG. 3 depicts operations of the network server of FIG. 1.

### DETAILED DESCRIPTION OF THE PREFERRED EMBODIMENTS

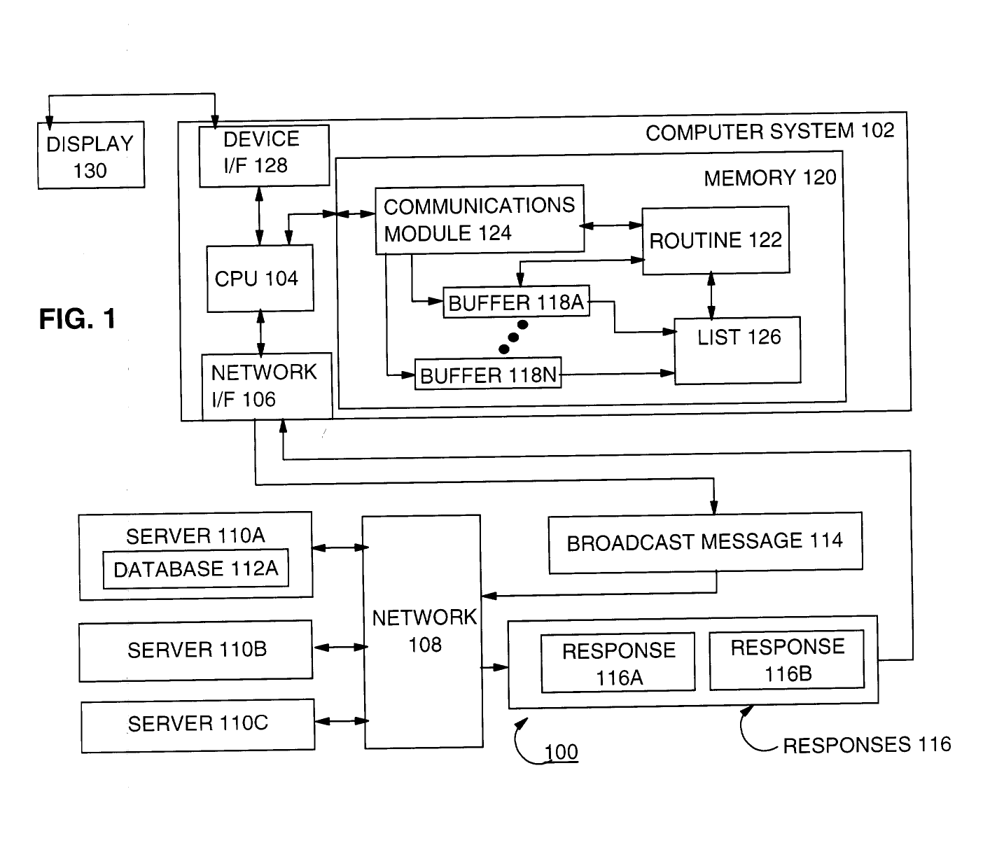

FIG. 1 depicts computer networked environment 100 including computer system 102 operatively connected to network 108. Network 108 is operatively connected to network servers 110A, 110B, 110C. Servers 110A and 110B are network servers that are capable of hosting a database. Depicted is server 110A hosting database 112A and server 110B not hosting any databases. network server 110C is not capable of hosting any databases. When servers 110A, 110B receive a request to identify whether they are capable of database hosting, servers 110A, 110B can transmit responses 116A and 116B respectively which identify themselves.

Computer system 102 includes CPU (Central Processing Unit) 104 operationally coupled to network interface (I/F) 106. CPU 104 is also operationally coupled to display 130 via device interface (I/F) 128. Network 108, such as the Internet, a LAN, or a WAN, is operationally coupled to network interface (I/F) 106.

Memory 120 is operationally coupled to CPU 104. Residing in memory 120 is identification mechanism (hereinafter called ‘routine’) 122. Routine 122 includes executable computer programmed program having instructions for directing CPU 104 to achieve specific functions and/or tasks as will be described below. In an alternative embodiment, routine 122 can be implemented as a hardware system having discrete hardware components, can be implemented as a combination of computer programmed instructions and discrete hardware components. It will be appreciated that hardware components and software modules are functionally equivalent. For ease and flexibility associated with constructing computer programmed instructions, routine 122 is implemented as executable computer programmed software in the preferred embodiment. In addition to routine 122 residing in memory 120, communications module 124, a set of buffers 118A to 118N, and list 126 also reside in memory 120. Communications module 124 communicates with network 108 via network interface 106.

Routine 122 instructs communications module 124 to allocate memory for receiving responses from servers operatively connected to network 108. An example of allocated memory is depicted as buffers 118A to 118N. Once buffers 118A to 118N are substantially filled, routine 122 can generate list 126 (for containing the contents of buffers 118A to 118N) that identifies network servers capable of database hosting (such as servers 110A, 110B)

Routine 122 issues broadcast message 114 via network 108. Broadcast message 114 is a request for requesting identification of a network server capable of database hosting network servers (110A, 110B) respond to broadcast message 114 by issuing respective responses (116A, 116B). Routine 122 waits for responses (116A, 116B) to arrive from network servers 100A, 100B (which when they arrive to interface 106, they will be placed into memory buffers 118A to 118N). The amount of time that routine 122 waits for the responses can be varied accordingly. Subsequently, routine 122 transfers the contents of the buffers 118A to 118N into list 126. When CPU 104 receives an appropriate command from routine 122, CPU 104 will place list 126 to display 130 via device interface 128. A user can view list 126 via display 130. Alternatively, buffers 118A to 118N can be located in other computer-readable media such as a hard disk drive, a CD (compact disk), or a floppy disk. It will be appreciated that before another broadcast message is transmitted, buffers 118A to 118N are reset (that is emptied) and made ready to receive new transmitted responses.

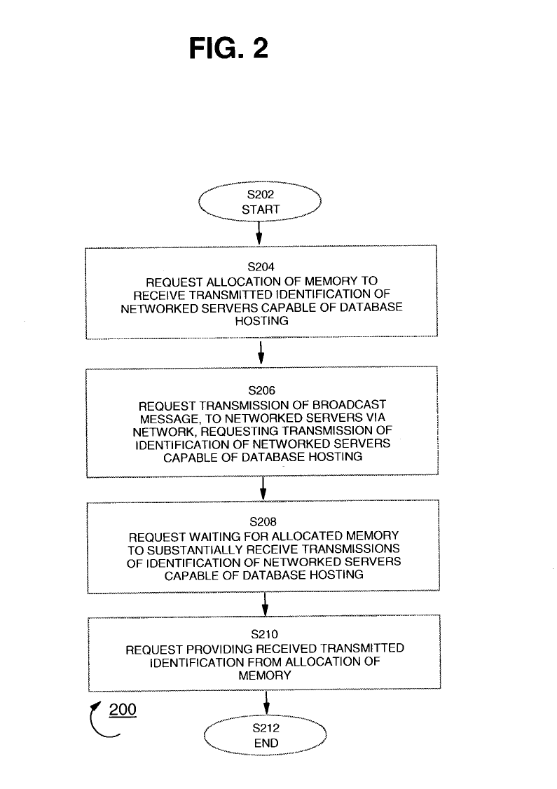

FIG. 2 depicts operations 200 of routine 122 of FIG. 1. It will be appreciated that the operations 200 will be performed by routine 122 unless indicated otherwise.

Routine 122 begins operations for identifying network servers 110A, 110B capable of database hosting. network servers 110A, 110B are also capable of transmitting identification indicating capability of database hosting. Routine 122 operates over network 108 for numerous networking network servers (including, but not limited to, servers 110A, 110B, 110C) in which some of which are the numerous network servers (including, but not limited to, servers 110A, 110B) that are capable of database hosting (S202).

In S204, routine requests an allocation of memory to receive transmitted identification of network servers capable of database hosting. For example, routine 122 can allocate a set of memory buffers for use by communications module 124. An example of a communications module is NetBIOS. Preferably, routine 122 allocates a maximum number of memory buffers that communications module 124 is capable of handling or using. Communications module 124 is prepared ahead of time for dealing with a maximum number of possible transmitted responses so that there will be no need for intervention from routine 122 while the transmitted responses arrive from network 108 and are being assembled into memory buffers (depicted as buffers 118A to 118N).

In S206 routine 122 requests transmission of broadcast message 114 (which is transmitted to the network servers connected to network 108). Broadcast message 114 requests transmission of identification of network servers capable of database hosting from any network servers that receive broadcast message 114. Broadcast message 114 is transmitted from computer system 102 to any network servers currently connected to network 108. Network 108 conveys broadcast message 114 from routine 122 to network servers 110A, 110B, and 110C. Network 108 conveys server responses from the network servers back to routine 122. Only those servers having the capability perform database hosting will respond. All other servers (not capable of hosting a database) will ignore broadcast message 114. As depicted, server 110B transmits response 116B and then server 110A transmits response 116A. Server 110A is currently hosting database 110A. Server 110B is not currently hosting any databases (however, it is still capable of hosting a database and is capable of responding to broadcast message 114). Server 110C does not respond because this server is not capable of database hosting and does not have the capability to transmit a response when broadcast message 114 is received.

In S208, routine 122 requests waiting for the allocated memory to substantially receive transmissions of identification of network servers capable of database hosting. Preferably, routine 122 waits for a short time period to allow for transmitted responses to arrive into memory buffers 118A to 118N. Routine 122 allows for the wait time period to be adjustable so that the wait time period can be set optimally for different network environments.

In S210 routine 122 requests processing of the received transmitted identification (which is stored in the allocation of memory). Routine 122 processes the contents of memory buffers 118A to 118N and transfers the contents to list 126. Routine 122 makes an arrangement to have list 126 displayed on display 130 via device interface 128. In S212, operations of routine 122 stops.

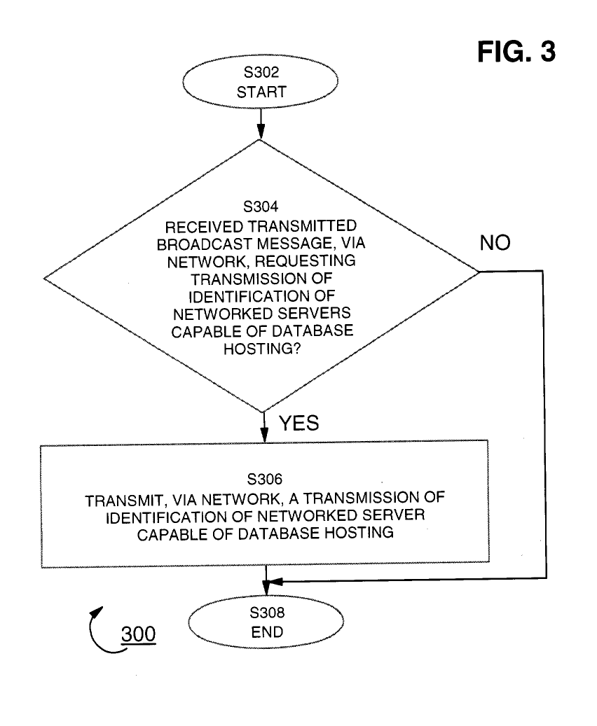

FIG. 3 depicts operations 300 of a server capable of database hosting. It will be appreciated that operations 300 will be performed by the server unless indicated otherwise. Operations 300 is performed by network servers 110A, 110B.

In S302, operations of a response mechanism (not depicted) incorporated in network server 110A begins. Preferably, the response mechanism is implemented as computer programmed software. The response mechanism will transmit identification indicating that network server 110A is capable of database hosting in response to receiving transmitted broadcast message 114 for requesting transmission of identification network servers capable of database hosting. The transmission mechanism will interact with network 108. In S304, the response mechanism ascertains whether server 110A has received transmitted broadcast message 114 via network 108. If the response mechanism ascertains that server 110A did receive transmitted broadcast message 114, then processing continues to S306. If the response mechanism ascertains that server 110A did not receive transmitted broadcast message 114, then processing continues to S308 (in which case operations of response mechanism stops).

In S306, the response mechanism requests transmission, via network 108, of identification of network server capable of database hosting in a response 116A. In S308 operations of the response mechanism stops. The present invention may be embodied in other specific forms without departing from the spirit or essential characteristics thereof. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

We claim:

1. A computer program product for use in a computer system operatively coupled to a computer readable memory, the computer program product including a computer-readable data storage medium tangibly embodying computer readable program instructions for implementing method acts comprising:
transmitting a broadcast message requesting identification responses from database compatible servers connected to a network to determine whether they are capable of hosting a database;
receiving said responses; and
storing said received responses in said memory and reading said stored responses from said memory after a predetermined period of time sufficient to enable storing of expected responses.

2. The product of claim 1 wherein said predetermined period of time is sufficient to receive all expected responses.

3. The product of claim 1 comprising a computer connectable to said network, said computer providing said memory.

4. A data processing system having an identification mechanism with associated memory for identifying database servers on a network capable of hosting databases, the system executing method acts comprising:
transmitting means for transmitting a broadcast message requesting identification responses from database compatible servers connected to a network to determine whether they are capable of hosting a database;
receiving means for receiving said responses; and
control means for storing said received responses in said memory and reading said stored responses from said memory after a predetermined period of time sufficient to enable storing of expected responses.

5. The system of claim 4 wherein said predetermined period of time is sufficient to receive all expected responses.

6. The system of claim 4 wherein said identification mechanism comprises a computer connectable to said network, said computer providing said memory.

7. A method executable by a computer system comprising:
transmitting a broadcast message requesting identification responses from database compatible servers connected to a network to determine whether they are capable of hosting a database;
receiving said responses; and
storing said received responses in said memory and reading said stored responses from said memory after a predetermined period of time sufficient to enable storing of expected responses.

8. The method of claim 7 wherein said predetermined period of time is sufficient to receive all expected responses.

9. The method of claim 7 comprising connecting a computer to said network, said computer providing said memory.

10. A method for use by a data processing system having memory for identifying database compatible servers connected to a network, comprising:
transmitting a broadcast message requesting responses from said database compatible servers to determine whether they are capable of hosting a database;
receiving said responses in said memory;
storing said responses in memory;
waiting for a preselected time sufficient to receive expected responses; and
reading said responses from said memory.

11. The method of claim 10 wherein said preselected time is sufficient to receive all expected responses.

12. The method of claim 10 comprising connecting a computer to said network, said computer providing said memory.

13. A data processing system having memory for identifying database compatible servers connected to a network, the system executing method acts comprising:
transmitting a broadcast message requesting responses from said database compatible servers to determine whether they are capable of hosting a database;
receiving said responses in said memory;
storing said responses in memory;
waiting for a preselected time sufficient to receive expected responses; and
reading said responses from said memory.

14. The system of claim 13 wherein said preselected time is sufficient to receive all expected responses.

15. The system of claim 13 comprising a computer connected to said network, said computer providing said memory.

16. A computer program product for use in a computer system operatively coupled to a computer readable memory, the computer program product including a computer-readable data storage medium comprising:
means for transmitting a broadcast message requesting responses from said database compatible servers to determine whether they are capable of hosting a database;
means for receiving said responses in said memory;
means for storing said responses in memory;
means for waiting for a preselected time sufficient to receive expected
responses; and
means for reading said responses from said memory.

17. The product of claim 16 wherein said preselected time is sufficient to receive all expected responses.

18. The product of claim 16 comprising a computer connected to said network, said computer providing said memory.

19. A method for allowing a database compatible server connected to a network to identify itself, comprising:
receiving a message requesting identification said database compatible server from a data processing system; and
preparing a response to said message requesting identification of said database compatible servers capable of hosting a database.

20. The method of claim 19 further comprising transmitting said response to said data processing system.

21. The method of claim 19 wherein said data processing system comprises a computer connectable to said network.

22. A computer program product for use in a computer system operatively coupled to a computer readable memory, the computer program product including a computer-readable data storage medium tangibly embodying computer readable program instructions for implementing method acts comprising:
receiving a message requesting identification said database compatible server from a data processing system; and
preparing a response to said message requesting identification of said database compatible servers capable of hosting a database.

23. The computer program product of claim 22, wherein the instructions include transmitting the response to the data processing system.

24. The product of claim 22 comprising a computer connectable to said network.

25. A system for allowing a database compatible server connected to a network to identify itself, comprising:
means for receiving a message requesting identification said database compatible server from a data processing system; and
means for preparing a response to said message requesting identification of said database compatible servers capable of hosting a database.

26. The system of claim 25 further comprising means for transmitting said response to said data processing system.

27. The system of claim 25 comprising a computer connectable to said network.

28. An identification mechanism for a database compatible server connectable to a network for sending and receiving messages for identifying database servers on a network capable of hosting databases, comprising:
receiving means for receiving a message requesting identification of said database compatible server from a data processing system;
responding means for responding to said message requesting identification to generate a response thereto identifying that said database compatible server is capable of hosting a database; and
transmitting means for transmitting said response to said data processing system.

29. The mechanism of claim 28 wherein the server is a computer connectable to said network.

30. The mechanism of claim 28 comprising means for transmitting said response within a predetermined time.

31. A method for a database compatible server connectable to a network for sending and receiving messages for identifying database servers on a network capable of hosting databases, comprising:
receiving a message requesting identification of said database compatible server from a data processing system;
responding to said message requesting identification to generate a response thereto identifying that said database compatible server is capable of hosting a database; and
transmitting said response to said data processing system.

32. The method of claim 31 wherein the server is a computer connectable to said network.

33. The method of claim 31 comprising transmitting said response within a predetermined time.

34. A computer program product for use in a computer system operatively coupled to a computer readable memory, the computer program product including a computer-readable data storage medium tangibly embodying computer readable program instructions for implementing method acts comprising:
receiving a message requesting identification of said database compatible server from a data processing system;
responding to said message requesting identification to generate a response thereto identifying that said database compatible server is capable of hosting a database; and
transmitting said response to said data processing system.

35. The product of claim 34 wherein the server is a computer connectable to said network.

36. The product of claim 34 wherein the method acts comprise transmitting said response within a predetermined time.
